(19) United States
(12) Patent Application Publication
(10) Pub. No.: US 2003/0118873 A1
(43) Pub. Date: Jun. 26, 2003

(54) Stabilized zirconia thermal barrier coating with hafnia

(76) Inventor: Kenneth S. Murphy, Norton Shores, MI (US)

Correspondence Address: Mr. Edward J. Timmer, Walnut Woods Centre, 5955 W. Main Street, Kalamazoo, MI, 49009, US

(21) Appl. No.: 10/024,518

(22) Filed: Dec. 21, 2001

(51) Int. Cl. B32B 9/00

(52) U.S. Cl. 428/701; 428/702; 428/699; 428/697

(57) ABSTRACT

A ceramic thermal barrier coating on a substrate wherein the coating comprises a stabilized zirconia coating including yttria and hafnia wherein the hafnia is present in an amount of at least about 15 weight % to substantially reduce thermal conductivity of the thermal barrier coating.

### FIELD OF THE INVENTION

The present invention relates to thermal barrier coatings for components exposed to elevated temperatures and, more particularly, to thermal barrier coatings having reduced thermal conductivity by virtue of coating compositional features.

### BACKGROUND OF THE INVENTION

Thermal barrier coating systems of various types are well known in the gas turbine engine industry for protecting nickel-based and cobalt-based superalloy components, such as turbine blades and vanes, from oxidation and corrosion during engine operation.

One type of thermal barrier coating system involves depositing on the superalloy component (substrate) to be protected a bondcoat comprising an MCrAlY alloy overlay where M is iron, nickel, cobalt, or a combination thereof, oxidizing the bondcoat to form an alumina layer in-situ thereon, and then depositing a ceramic thermal barrier coating having columnar morphology on the alumina layer. Such a thermal barrier coating is described in U.S. Pat. Nos. 4,321,310 and 4,321,311.

Another type of thermal barrier coating system exemplified by U.S. Pat. No. 5,238,752 involves forming on the superalloy component (substrate) to be protected a bondcoat comprising nickel aluminide (NiAl) or platinum-modified nickel aluminide diffusion layer. The bondcoat is oxidized to form a thermally grown alumina layer in-situ thereon, and then a ceramic thermal barrier coating having columnar morphology is deposited on the alumina layer.

Murphy U.S. Pat. Nos. 5,716,720 and 5,856,027 involves forming on the superalloy component to be protected a bondcoat comprising a chemical vapor deposited platinum-modified diffusion aluminide coating having an outer additive layer comprising an intermediate Ni-Al phase. The bondcoat is oxidized to form a thermally grown alumina layer in-situ thereon, and then a ceramic thermal barrier coating having columnar morphology is deposited on the alumina layer.

A widely used ceramic thermal barrier coating for aerospace applications to protect components, such as turbine blades, of the hot section of gas turbine engines comprises 7 weight % yttria stabilized zirconia (7YSZ). Two methods of applying this ceramic coating have been widely used. Electron beam physical vapor deposition (EBPVD) has been used to produce a coating columnar structure where the majority of coating porosity is located between relatively dense ceramic columns that extend generally perpendicular to the substrate/bondcoat.

Air plasma spraying also has been used to apply the 7YSZ ceramic coating in a manner to create about 10% by volume porosity in the as-deposited coating. This porosity is in the form of gaps between plasma “splat” layers and micro-cracking due to ceramic shrinkage. The thermal conductivity of as-manufactured plasma sprayed 7YSZ ceramic coatings generally is about 60% of that of the 7YSZ ceramic coatings applied by EBPVD.

In yttria stabilized zirconia ceramic coatings, a typical impurity is hafnia present in amount of about 1 to 2 weight % of the coating since hafnia is a naturally-occurring impurity in the oxides of zirconia. Hafnia and zirconia exhibit complete solid solubility across all compositions in their binary system as a result of their similar chemical properties and essentially equal ionic radii of 0.78 Angstroms for Hf⁺⁴ and 0.79 Angstroms for Zr⁺⁴.

An object of the present invention is to provide a stabilized zirconia thermal barrier coating and coating method wherein the coating has reduced thermal conductivity by virtue of intentional inclusion of hafnia in amounts above impurity levels.

### SUMMARY OF THE INVENTION

The present invention provides a thermal barrier coating on a metallic substrate as well as method of coating wherein at least a portion of the coating comprises a stabilized zirconia coating including hafnia present in an amount found unexpectedly to be effective to reduce thermal conductivity of the thermal barrier coating.

In an illustrative embodiment of the invention, hafnia is present in an amount of at least about 15 weight % to about 64 weight %, and preferably from about 15.8 to about 63.4 weight %, of the coating. Yttria can be present in an amount to stabilize the tetragonal phase of zirconia and preferably is present from about 2.0 to about 36.6 weight %.

A preferred coating comprises about 34.3 to about 61.6 weight % hafnia, 5.3 to 11.8 weight % yttria and balance zirconia. An even more preferred coating comprises about 58.1 to about 59.7 weight % hafnia, 5.3 to 8 weight % yttria and about 34 to about 35 weight % zirconia. The thermal conductivity of the thermal barrier coating can be reduced by 20% or more by inclusion of hafnia in the coating.

The thermal barrier coating including hafnia as described can comprise the entire coating thickness or one or more layer portions of a multi-layer or multi-zone thermal barrier coating.

Advantages and objects of the invention will become more readily apparent from the following detailed description taken with the following drawings.

### DESCRIPTION OF THE DRAWINGS

FIG. 1 is a perspective view of a gas turbine engine blade that can be coated with a thermal barrier coating pursuant to the invention.

FIG. 2 is schematic sectional view of a thermal coating system.

FIG. 3 is a graph of thermal conductivity versus temperature for various thermal barrier coatings including coatings pursuant to the invention designated 7Y46HfZrO and 20Y40HfZr.

FIG. 4 is a schematic view of EBPVD apparatus that can be used to practice the invention.

### DESCRIPTION OF THE INVENTION

The present invention can be used to protect known nickel based and cobalt based superalloy substrates which may comprise equiaxed, DS (directionally solidified) and SC (single crystal) investment castings as well as other forms of these superalloys, such as forgings, pressed superalloy powder components, machined components, and other forms. For example only, representative nickel base superalloys include, but are not limited to, the well known Rene' alloy N5, MarM247, CMSX-4, PWA 1422, PWA 1480, PWA 1484, Rene' 80, Rene' 142, and SC 180 used for making SC and columnar grain turbine blades and vanes. Cobalt based superalloys which can be protected by the thermal barrier coating system include, but are not limited to, FSX-414, X-40, and MarM509. The invention is not limited to nickel or cobalt based superalloys can be applied to a variety of other metals and alloys to protect them at elevated superambient temperatures.

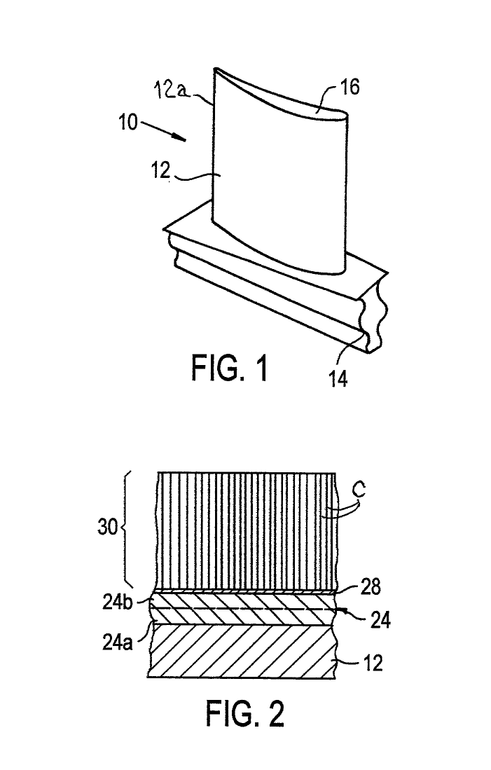

For purposes of illustration and not limitation, FIG. 1 illustrates a nickel or cobalt based superalloy turbine blade 10 that can be made by investment casting and protected by a coating pursuant to an embodiment of the invention. The blade 10 includes an airfoil section 12 against which hot combustion gases from the combustor are directed in a turbine section of the gas turbine engine. The blade 10 includes a root section 14 by which the blade is connected to a turbine disc (not shown) using a fir-tree connection in well known conventional manner and a tip section 16. Cooling bleed air passages (not shown) can be formed in the blade 10 to conduct cooling air through the airfoil section 12 for discharge through discharge openings (not shown) at the trailing edge 12a of the airfoil 12 and/or at the tip 16 in well known conventional manner.

The airfoil 12 can be protected from the hot combustion gases in the turbine section of the gas turbine engine by coating it with a thermal barrier coating (TBC) system preferably comprising a metallic bondcoat 24 formed or applied on the nickel or cobalt base superalloy airfoil (substrate) 12, FIG. 2. The bondcoat 24 preferably has a thin aluminum oxide (alumina) layer 28 formed thereon. A thermal barrier coating (TBC) 30 pursuant to an embodiment of the invention is deposited on the layer 28.

The metallic bondcoat 24 can be selected from a modified or unmodified aluminide diffusion coating or layer, an MCrAlY overlay coating where M is selected from the group consisting of Ni and Co, an aluminized MCrAlY overlay, and other conventional bondcoats. A preferred bondcoat 24 comprises an outwardly grown, Pt-modified aluminide diffusion coating 24 that is formed by chemical vapor deposition (CVD) on the substrate as described in U.S. Pat. No. 5,716,720 and known commercially as MDC-150L coating, the teachings of the '720 patent being incorporated herein by reference to this end.

An MCrAlY overlay that can be used as bondcoat 24 is described in U.S. Pat. Nos. 4,321,310 and 4,321,311. A CVD aluminized MCrAlY overlay that can be used as bondcoat 24 is described in Warnes et al. U.S. Pat. No. 6,129,991, the teachings of all of the above patents being incorporated herein by reference.

The MDC-150L Pt-modified diffusion aluminide bondcoat 24 includes an inner diffusion zone 24a proximate the superalloy airfoil (substrate) 12 and an outer layer region 24b comprising a platinum-modified (platinum-bearing) intermediate phase of aluminum and nickel (or cobalt depending on the superalloy composition) as described in the '720 patent. The overall thickness of the bondcoat typically is in the range of about 1.5 to about 3.0 mils, although other thicknesses can be used in practice of the invention.

The bondcoat 24 may optionally be surface finished for the purpose of promoting adherence of the TBC 30 and layer 28 to bondcoat 24. An MCrAlY bondcoat may be surface finished as described in U.S. Pat. No. 4,321,310. A diffusion aluminide bondcoat may be surface finished by media bowl polishing as described in copending application Ser. No. 09/511857 of common assignee herewith, the teachings of which are incorporated herein by reference. Other suitable surface finishing techniques may be used to reduce the surface roughness of the bondcoat in practice of the invention.

A thin adherent aluminum oxide (alumina) layer 28 preferably is thermally grown on the bondcoat 24. The oxide layer 28 can be formed in a separate oxidation step conducted prior to depositing the ceramic thermal barrier coating 30, or in a preheating step of the EBPVD process employed to deposit the coating 30, or using any other technique effective to form the oxide layer 28. The aluminum oxide layer 28 may include other elements as a result of diffusion from the substrate and/or as a result of doping the oxide layer 28. When the bondcoat 24 comprises the MDC-150L coating, the MDC-150L bondcoat is oxidized in a low partial pressure oxygen atmosphere, such as a vacuum less than 10⁻⁴ torr, or in argon or hydrogen partial pressure atmospheres having oxygen impurities, at temperatures greater than about 1800 degrees F. that promote in-situ formation of the alumina layer 28 as described in above U.S. Pat. No. 5,716,720. For purposes of illustration and not limitation, the alumina layer can be formed in-situ by initially evacuating a vacuum furnace to 1×10⁻⁶ torr (pressure level subsequently increases due to furnace degassing to 1×10⁻⁴ torr to 1×10⁻³ torr), ramping the substrate having the MDC-150L bondcoat thereon to 1975 degrees F., holding at temperature for 2 hours, and cooling to room temperature for removal from the furnace. The oxide layer 28 produced is a continuous film of alumina. The thickness of the alumina layer can be in the range of about 0.01 to 2 microns, although other thicknesses can be used in practice of the invention. Another oxidation treatment is described in above copending application Ser. No. 09/511857 of common assignee herewith and incorporated herein by reference.

The thermally grown alumina layer 28 receives the outer ceramic thermal barrier coating (TBC).

For purposes of illustrating an embodiment of the invention, the TBC 30 comprises a stabilized zirconia thermal barrier coating having reduced thermal conductivity by virtue of intentional inclusion of hafnia in amounts above impurity levels. Hafnia is included in the coating in an amount above typical impurity level and found unexpectedly to be effective to reduce thermal conductivity of the thermal barrier coating.

In an illustrative embodiment of the invention, hafnia is present in an amount of at least about 15 weight % to about 64 weight %, and preferably from about 15.8 to about 63.4 weight %, of the coating. Yttria can be present in an amount to stabilize the tetragonal phase of zirconia and preferably is present from about 2.0 to about 36.6 weight %.

A preferred thermal barrier coating pursuant to an illustrative embodiment of the invention comprises about 34.3 to about 61.6 weight % hafnia, 5.3 to 11.8 weight % yttria and balance zirconia. An even more preferred coating comprises about 58.1 to about 59.7 weight % hafnia, 5.3 to 8 weight % yttria and about 34 to about 35 weight % zirconia. The thermal conductivity of the thermal barrier coating can be reduced by 20% or more by inclusion of hafnia in the coating to provide a coating that exhibits a thermal conductivity of less than 1.5 W/m-K.

The TBC 30 can comprise a multi-layer or multi-zone thermal barrier coating wherein one or more layer portions of the coating including hafnia pursuant to the invention. That is, the entire thickness of the TBC 30 can comprise the hafnia-bearing coating pursuant to the invention, or only one or more layers of the TBC can comprise a hafnia-bearing coating layer pursuant to the invention. Moreover, the morphology or structure of the TBC 30 can be controlled as taught in copending application entitled “THERMAL BARRIER COATING” (attorney docket No. MP293) of common inventorship herewith, to further reduce thermal conductivity of TBC 30 by virtue of both its composition pursuant to this invention and its morphology. Layered or graded TBC coating structures also can be used to this end.

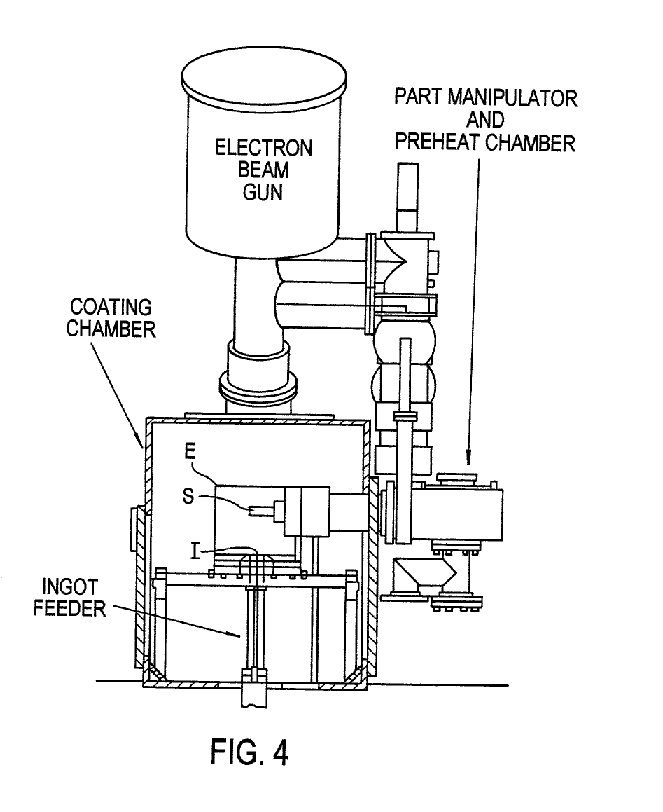

The TBC 30 can be deposited by electron beam physical vapor deposition (EBPVD) on the oxide layer 28 using EBPVD apparatus shown schematically in FIG. 4 wherein an ingot I of ceramic thermal barrier coating material is fed by the ingot feeder shown for heating and evaporation by an electron beam from the electron beam gun and condensed on the alumina layer 28 of the airfoil substrate(s) 12 positioned and rotated in a coating chamber typically above the ingot I in the vapor cloud comprising evaporated ceramic material.

The gas pressure in the coating chamber is controlled to produce a TBC coating having a conventional columnar coating structure comprising columnar grains C typically present for commonly used 7 weight % yttria stabilized zirconia deposited by EBPVD. For example, an oxygen pressure controlled at 6 microns plus or minus 2 microns can be used to this end. Alternately, a higher oxygen pressure of 20 microns plus or minus 2 microns can be used to produce a TBC coating structure comprising primary columnar grains that extend transversely of the surface of substrate 12 and that in addition have secondary columnar grains that extend laterally therefrom relative to a respective column axis as described in related copending application entitled “THERMAL BARRIER COATING” of common inventorship herewith, the teachings of which are incorporated herein by reference. The morphology or microstructure of the TBC produced at the higher oxygen partial pressure exhibit reduced thermal conductivity as compared to a conventional thermal barrier coating having only columnar grains. Typical thickness of the conventional ceramic coating is in the range of 5 to 20 mils.

### EXAMPLES

Sapphire specimens were used as substrates on which TBC's were deposited by EBPVD and then the coated substrates were fractured to study the microstructure of the TBC. The sapphire substrates comprised sapphire with a surface finish produced by grit blasting with alumina (corundum) of less than 220 mesh at 20-25 psi air pressure. Nickel base superalloy CMSX-4 disc specimens were coated with about 12 mils (0.012 inch) of TBC for thermal diffusivity measurements [disc specimens were 0.5 inch diameter and 20 mils (0.020 inch) in thickness]. Nickel base superalloy Rene' 80 specimens were grit blasted in a same manner as the sapphire specimens coated with about 12 mils of TBC for coating density measurements (specimens were 1 inch by 1 inch by 125 mils thick.

The sapphire and nickel base superalloy substrates designated S in FIG. 4 were mounted on a rotatable shaft (part manipulator) and were heated to 1975 degrees F. (plus or minus 25 degrees F.) in the loading/preheat chamber. The coating chamber was evacuated to below 1×10⁻⁴ torr. Oxygen was introduced into the coating chamber until a stabilized oxygen pressure of 6 microns plus or minus 2 microns was achieved. An electron beam (power level of 75 kW plus or minus 10 kW) from the electron beam gun was scanned (rate of 750 Hertz) over the end of a ceramic ingot I to evaporate it. The ingot I comprised 7 weight % yttria-46 weight % hafnia-balance zirconia (7Y46HfZrO specimens) in some tests of the invention and 20 weight % yttria-40 weight 6 hafnia-balance zirconia (20Y40HfZrO specimens) in other tests of the invention. The electron beam scanned the ingot at an angle to avoid the substrates and back reflection of the beam. To minimize heat loss, the preheated coated substrate(s) S then were rapidly moved on the shaft from the loading/preheat chamber to a coating position in heat reflective enclosure E in the coating chamber above the ingot I after EB melting of the ingot I was initiated. The enclosure included an opening for the electron beam to enter. The substrates were rotated by the shaft at a speed of 20 rpm plus or minus 2 rpm about 14 inches above the ingot, although the spacing can be from about 10-15 inches. Deposition was conducted for a time to produce a white colored near-stoichiometric 7 weight % yttria-46 weight % hafnia-balance zirconia ceramic coating or 20 weight % yttria-40 weight % hafnia-balance zirconia ceramic coating on the substrates depending on the ingot composition used. Typical thickness of the ceramic coating was in the range of 5 to 15 mils (0.005 to 0.020 inch). A thickness of TBC 30 of about 12-15 mils was deposited for thermal conductivity testing.

For comparison, similar substrate specimens were EBPVD coated under similar conditions to produce conventional 7 weight % yttria stabilized zirconia (7YSZ specimens) and a 20 weight % yttria stabilized zirconia (20YSZ specimens) ceramic coatings both having hafnia only in an impurity amount (e.g about 1 to 2 weight % hafnia in the TBC).

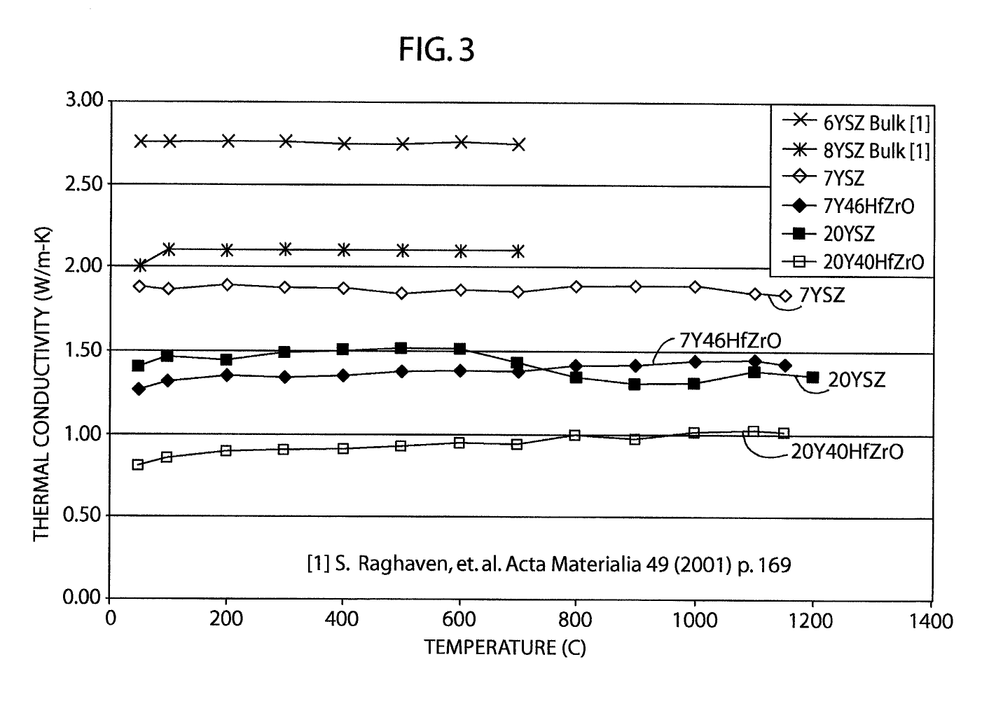

The thermal conductivity of the ceramic coatings represented in FIG. 3 was determined by the laser flash technique ASTM E1461 procedure because creation of bulk ceramic coating samples is not practical nor representative of the relatively thin ceramic TBC coating produced on actual components for service in a gas turbine engine for example. The technique requires measurement of three parameters from the substrate and ceramic coating; namely, specific heat, thermal diffusivity, and density. Representative substrate (e.g. CMSX-4 nickel base superalloy) and ceramic TBC material were measured to provide specific heat values versus temperatures. An uncoated substrate (e.g. CMSX-4 nickel base superalloy) nominally 0.5 inch in diameter by 0.020 inch thick) was measured for thermal diffusivity versus temperature. A TBC coated substrate (nominal coating thickness of 0.105 inch) was measured for thermal diffusivity versus temperature). Knowing the thermal diffusivity of the substrate and the TBC coating on a substrate, the thermal diffusivity of the coating alone can be determined. Subsequent destructive testing was performed to measure substrate and coating thickness of the diffusivity samples. Coating thermal conductivity is calculated by multiplying the coating specific heat times the coating thermal diffusivity, and times the coating density.

FIG. 3 is a graph of thermal conductivities of the 7Y46HfZrO ceramic coating of the invention (see solid diamond data points) and 20Y40HfZrO ceramic coating of the invention (see open square data points) and the conventional 7YZS and 20YZS ceramic coatings at different temperatures. The thermal conductivity of bulk 6YSZ and 8YSZ are shown for comparison purposes and were obtained from S. Raghaven et al., ACTA MATERIALIA, 49, page 169, (2001).

It is apparent that the ceramic coating designated 7Y46HfZrO pursuant to the invention exhibited a substantially reduced thermal conductivity at all temperatures from 25 degrees C. up to 1150 degrees C. as compared to that of the conventional 7YSZ ceramic coating having the same yttria content. The same is true with respect to the ceramic coating designated 20Y40HfZrO pursuant to the invention as compared to that of the conventional 20YSZ ceramic coating having the same yttria content. For example, generally, the thermal conductivity of the ceramic coating designated 7Y46HfZrO pursuant to the invention was 20% of that of the conventional 7YSZ ceramic coating at the temperature tested. The thermal conductivity of the ceramic coating designated 20Y40HfZrO pursuant to the invention was 25% of that of the 20YSZ ceramic coating at the temperature tested. These significant and unexpected reductions in thermal conductivity are advantageous in that they allow thermal barrier coatings to be used that further reduce the temperature of the substrate (e.g. airfoil 12) or allow a thinner thermal barrier coating to be applied while maintaining the same airfoil temperature.

Although the invention has been described with respect to certain embodiments thereof, it is not limited thereto and modifications and changes can be made thereto within the spirit and scope of the invention cope as set forth in the appended claims

I claim

1. A ceramic thermal barrier coating wherein at least a portion of the coating comprises a stabilized zirconia coating including hafnia in an amount effective to reduce thermal conductivity of the thermal barrier coating as compared to a similar coating having an impurity amount of hafnia.

2. The coating of claim 1 wherein hafnia is present in an amount of at least about 15 weight % of the coating.

3. The coating of claim 2 comprising about 15.8 to about 63.4 weight % hafnia, about 2.0 to about 36.6 weight % yttria, and balance zirconia.

4. The coating of claim 3 comprising about 34.3 to about 61.6 weight % hafnia, about 5.3 to about 11.8 weight % yttria, and balance zirconia.

5. The coating of claim 4 comprising about 58.1 to about 59.7 weight % hafnia, about 5.3 to about 8 weight % yttria, and about 34 to about 35 weight % zirconia.

6. The coating of claim 5 that exhibits thermal conductivity of less than 1.5 W/m-K.

7. An article comprising a metallic substrate and a ceramic coating on a surface of said substrate, said coating having at least a portion comprising a stabilized zirconia coating including hafnia in an amount effective to reduce thermal conductivity of the thermal barrier coating as compared to a similar coating having an impurity amount of hafnia.

8. The article of claim 7 wherein hafnia is present in the coating in an amount of at least about 15 weight % to about 64 weight % of the coating.

9. The article of claim 8 wherein the coating comprises about 15.8 to about 63.4 weight % hafnia, about 2.0 to about 36.6 weight % yttria, and balance zirconia.

10. The article of claim 9 wherein the coating comprises about 34.3 to about 61.6 weight % hafnia, about 5.3 to about 11.8 weight % yttria, and balance zirconia.

11. The article of claim 10 wherein the coating comprises about 58.1 to about 59.7 weight % hafnia, about 5.3 to about 8 weight % yttria, and about 34 to about 35 weight % zirconia.

12. The article of claim 11 wherein the coating exhibits a thermal conductivity of less than 1.5 W/m-K.

13. The article of claim 7 wherein said substrate comprises a superalloy gas turbine engine blade or vane.

14. The article of claim 7 further including a bondcoat between said coating and said substrate.

15. A method of protecting a surface of a metallic substrate, comprising:
depositing a coating comprising zirconia, yttria and hafnia wherein the hafnia is present in the coating in an amount effective to reduce thermal conductivity of the coating deposited on the substrate as compared to a similar coating having an impurity amount of hafnia.

16. The method of claim 15 wherein hafnia is present in the coating in an amount of at least about 15 weight % to about 64 weight % of the coating.

17. The method of claim 16 wherein the coating comprises about 15.8 to about 63.4 weight % hafnia, about 2.0 to about 36.6 weight % yttria, and balance zirconia.

18. The method of claim 17 wherein the coating comprises about 34.3 to about 61.6 weight % hafnia, about 5.3 to about 11.8 weight % yttria, and balance zirconia.

19. The article of claim 18 wherein the coating comprises about 58.1 to about 59.7 weight % hafnia, about 5.3 to about 8 weight % yttria, and about 34 to about 35 weight % zirconia.
